(19) United States
(12) Patent Application Publication
(10) Pub. No.: US 2017/0213422 A1
(43) Pub. Date: Jul. 27, 2017

(54) HOCKEY THEMED HYBRID GAME

(71) Applicant: Gamblit Gaming, LLC, Glendale, CA (US)

(72) Inventor: Miles Arnone, Sherborn, MA (US)

(21) Appl. No.: 15/483,773

(22) Filed: Apr. 10, 2017

Related U.S. Application Data
(63) Continuation of application No. 14/255,919, filed on Apr. 17, 2014.
Application No. 14/255,919 is a continuation of application No. PCT/US13/43185, filed on May 29, 2013.
(60) Provisional application No. 61/652,736, filed on May 29, 2012.

(51) Int. Cl. G07F 17/32; A63F 13/812

(52) U.S. Cl. CPC G07F 17/3286; G07F 17/3223; G07F 17/3244; G07F 17/3262; G07F 17/3288; A63F 13/812

(57) ABSTRACT

An electromechanical gaming machine in a distributed system constructed to receive real credits from a player to execute a wager and provide a hockey-themed d entertainment game in which a user controls a controllable element using a game world clock. Events within the entertainment portion of the hockey themed entertainment game can trigger wagers in a real world game of chance. The outcome of the wagers can result in payouts of real world credit and can also affect gameplay within the hockey themed entertainment game.

### CROSS REFERENCE TO RELATED APPLICATIONS

The current application is a continuation of U.S. patent application Ser. No. 14/255,919 filed on Apr. 17, 2014, which is a continuation of Patent Cooperation Treaty Application No. PCT/US2013/043185 filed on May 29, 2013, which claims the benefit of U.S. Provisional Patent Application No. 61/652,736, filed on May 29, 2012, the contents of each of which are hereby incorporated by reference in their entirety as if stated in full herein.

### FIELD OF THE INVENTION

Embodiments of the present invention are generally related to gaming and more specifically to hockey themed hybrid games that include both a hockey themed entertainment game and a gambling game.

### BACKGROUND

The gaming machine manufacturing industry has traditionally developed gaming machines with a gambling game. A gambling game is typically a game of chance, which is a game where the outcome of the game is generally dependent solely on chance (such as a slot machine). A game of chance can be contrasted with a game of skill where the outcome of the game can depend upon a player's skill with the game. Gambling games are typically not as interactive and do not include graphics as sophisticated as an entertainment game, which is a game of skill such as a video game.

### SUMMARY OF THE INVENTION

Systems and methods in accordance with embodiments of the invention operate a hockey themed hybrid game in which a user controls a controllable element to maneuver a hockey puck into an opponent's goal and events within the entertainment portion of the hockey themed entertainment game trigger wagers in a real world game of chance, the outcome of which can impact gameplay within the hockey themed entertainment game. One embodiment of the invention includes a real world engine constructed to provide a randomly generated payout of real world credits from a wager in a gambling game, an entertainment software engine constructed to execute a hockey themed entertainment game providing outcomes based upon skillful execution of the hockey themed entertainment game to earn a payout of game world credits including maneuvering a controllable element within the hockey themed entertainment game to direct a virtual object into an opponent's goal, a user interface that depicts a representation of the hockey themed entertainment game and receives instructions for controlling the controllable element within the hockey themed entertainment game; and a game world engine constructed to: monitor hockey themed entertainment game gameplay for a gambling event occurrence detected from the skillful execution of the hockey themed entertainment game in accordance with at least one gambling event occurrence rule; communicate the gambling event occurrence to the real world engine, where the gambling event occurrence triggers a wager made in accordance with a wager execution rule within the gambling game executed by the real world engine to produce a wager payout as a randomly generated payout of gameplay resources from the wager; and generate an entertainment game gameplay modification that can be used to modify hockey themed entertainment game gameplay based upon the wager payout.

In a further embodiment, the gambling event occurrence is passage of a period of time during hockey themed entertainment game gameplay.

In another embodiment, the entertainment game modification is an addition of a period of time available for hockey themed entertainment game gameplay.

In a still further embodiment, the gambling event occurrence is passage of a period of time during hockey themed entertainment game gameplay, and the entertainment game modification is an addition of a period of time available for hockey themed entertainment game gameplay.

In still another embodiment, the entertainment game modification is an addition of a period of time available for hockey themed entertainment game gameplay in a future entertainment game gameplay session for a player associated with a player profile.

In a yet further embodiment, the entertainment game modification is an additional hockey themed entertainment game gameplay session available for a player associated with a player profile.

In yet another embodiment, the gambling event occurrence is a final result within a hockey themed entertainment game gameplay session for a player associated with a player profile.

In a further embodiment again, the gambling event occurrence is the controllable element within the hockey themed entertainment game directing a virtual object into an opponent's goal during a hockey themed entertainment game gameplay session.

In another embodiment again, the gambling event occurrence is an opponent directing a virtual object into a player's own goal during a hockey themed entertainment game gameplay.

In a further additional embodiment, the user interface depicts a controllable element including a hockey stick.

In another additional embodiment, gameplay resources wagered in a wager comprises gameplay resources selected from the group consisting of: real world credits, game world credits and elements, where elements are a limited resource consumed within the hockey themed entertainment game to advance hockey themed entertainment game gameplay.

In a still yet further embodiment, gameplay resources wagered in a wager comprises real world credits.

In still yet another embodiment, at least one gambling event occurrence rule detects the gambling event occurrence as a player action that is a consumption of an element, where an element is a limited resource consumed within the hockey themed entertainment game to advance hockey themed entertainment game gameplay.

In a still further embodiment again, at least one gambling event occurrence rule detects the gambling event occurrence as a player action that achieves a combination of elements associated with a player profile, where elements are a limited resource consumed within the entertainment game to advance entertainment game gameplay.

In still another embodiment again, a player of the hockey themed hybrid game is an electronic representation of interactions received at the user interface associated with a player profile of the hockey themed hybrid game.

In a still further additional embodiment, the gambling event occurrence is a hockey related player action during hockey themed entertainment game gameplay performed by a player associated with a player profile.

An embodiment of the method of the invention includes initiating a hockey themed entertainment game gameplay session using a hockey themed hybrid game including: a real world engine constructed to provide a randomly generated payout of real world credits from a wager in a gambling game; an entertainment software engine constructed to execute a hockey themed entertainment game providing outcomes based upon skillful execution of the hockey themed entertainment game to earn a payout of game world credits including maneuvering a controllable element within the hockey themed entertainment game to direct a virtual object into an opponent's goal; and a user interface that depicts a representation of the hockey themed entertainment game and receives instructions for controlling the controllable element within the hockey themed entertainment game; a game world engine. In addition, the method includes monitoring hockey themed entertainment game gameplay for a gambling event occurrence detected from the skillful execution of the hockey themed entertainment game in accordance with at least one gambling event occurrence rule using the game world engine, communicating the gambling event occurrence to the real world engine using the game world engine, where the gambling event occurrence triggers a wager made in accordance with a wager execution rule within the gambling game executed by the real world engine to produce a wager payout as a randomly generated payout of gameplay resources from the wager, and generating an entertainment game gameplay modification that can be used to modify hockey themed entertainment game gameplay based upon the wager payout using the game world engine.

### BRIEF DESCRIPTION OF THE DRAWINGS

FIG. 1 illustrates a hockey themed hybrid game in accordance with an embodiment of the invention.

FIG. 2 is a conceptual diagram that illustrates how resources are utilized in a hockey themed hybrid game in accordance with an embodiment of the invention.

FIG. 3 is a conceptual diagram that illustrates interplay between resources and components of a hockey themed hybrid game in accordance with an embodiment of the invention.

FIG. 4 is a timing diagram that illustrates a process of facilitating interactions between a hockey themed entertainment game and a gambling game in accordance with an embodiment of the invention.

FIG. 5 is a system diagram that illustrates a network distributed hockey themed hybrid game in accordance with an embodiment of the invention.

FIG. 6 is a system diagram that illustrates an implementation of a network distributed hockey themed hybrid game with a local device user interface in accordance with an embodiment of the invention.

FIG. 7 is a system diagram that illustrates an implementation of a network distributed hockey themed hybrid game including a game world engine group server in accordance with an embodiment of the invention.

FIG. 8 is a system diagram that illustrates an implementation of an Internet distributed hockey themed hybrid game in accordance with an embodiment of the invention.

FIG. 9 is a system diagram that illustrates an implementation of a network distributed hockey themed hybrid game on multiple devices in accordance with an embodiment of the invention.

FIG. 10 is a conceptual diagram illustrating relationships between hockey themed player actions and various elements and credits used in hockey themed entertainment game gameplay in accordance with an embodiment of the invention.

FIG. 11 is a conceptual diagram illustrating how elements can be used to trigger a wager during hockey themed entertainment game gameplay in accordance with an embodiment of the invention.

FIG. 12 is a conceptual diagram illustrating how elapsed time can be used to trigger a wager during hockey themed entertainment game gameplay in accordance with an embodiment of the invention.

FIG. 13 illustrates a hardware architecture diagram of a processing apparatus utilized in the implementation of a hockey themed hybrid game in accordance with an embodiment of the invention.

### DETAILED DESCRIPTION

Turning now to the drawings, systems and methods for operation of hockey themed hybrid games are illustrated. In several embodiments, a hockey themed hybrid game is a form of a hybrid game that integrates both a gambling game that includes a real world engine (RWE) which manages the gambling game, as well as a hockey themed entertainment game that includes a game world engine (GWE) which manages the configuration of the hockey themed entertainment game, and an entertainment software engine (ESE) which executes the hockey themed entertainment game for user entertainment. In certain embodiments, the hockey themed hybrid game also includes a user interface associated with either or both the gambling game and the entertainment game. A player of a hockey themed hybrid game is the electronic representation of interactions, typically via a user interface, associated with a player profile of the hockey themed hybrid game. In operation of a hockey themed hybrid game, a player acts upon various types of elements of the entertainment game in a game world environment. In certain embodiments of a hockey themed hybrid game, a player can control a team or a character in a hockey themed entertainment game that uses a stick to maneuver an object into an opponent's goal to score points within the context of the hockey themed entertainment game. Elements are a limited resource consumed within an entertainment game to advance entertainment game gameplay. In playing the entertainment game using the elements, a player can (optionally) consume and accrue game world credits (GWC) within the entertainment game. These credits can be in the form of (but are not limited to) game world credits, experience points, or points generally. Wagers can be made in the gambling game using real world credits (RWC). The real world credits can be credits in an actual currency, or can be credits in a virtual currency which has real world value. Gambling outcomes from the gambling game can cause consumption, loss or accrual of RWC. In addition, gambling outcomes in the gambling game can influence elements in the entertainment game such as (but not limited to) restoring a consumed element, causing the loss of an element, restoration or placement of a fixed element. In certain embodiments, gambling games can facilitate the wager of GWC for a randomly generated payout of GWC or a wager of elements for a randomly generated payout of elements. In particular embodiments, an amount of GWC and/or elements used as part of a wager can have a RWC value if cashed out of a hockey themed hybrid game gameplay session. Example elements include enabling elements (EE) which are elements that enable a player's play of the entertainment game and whose consumption by the player while playing the entertainment game can trigger a wager in a gambling game. Another example of an element is a reserve enabling element (REE), which is an element that converts into one or more enabling elements upon occurrence of a release event in hybrid game gameplay. Other types of elements include actionable elements (AE) which are elements that are acted upon to trigger a wager in the gambling game and cannot be restorable during normal play of the entertainment game. In progressing through entertainment game gameplay, elements can be utilized by a player during interactions with a controlled entity (CE) which is a character, entity, inanimate object, device or other object under control of a player. Also, entertainment game gameplay progress can be dependent upon: a required game object (RGO) which is a specific game object in an entertainment game acted upon for an AE to be completed (such as but not limited to a specific key needed to open a door); a required environmental condition (REC) which is a game state present within an entertainment game for an AE to be completed (such as but not limited to daylight whose presence enables a character to walk through woods); or a controlled entity characteristic (CEC) which is a status of the CE within an entertainment game for an AE to be completed (such as but not limited to a CE to have full health points before entering battle). Although various gameplay resources, such as but not limited to GWC, RWC and elements are discussed above, any gameplay resource can be utilized to advance hockey themed hybrid game gameplay as appropriate to the specification of a specific application in accordance with embodiments of the invention. Various hybrid games are discussed in Patent Cooperation Treaty Application No. PCT/US11/26768, filed Mar. 1, 2011, entitled ENRICHED GAME PLAY ENVIRONMENT (SINGLE and/or MULTIPLAYER) FOR CASINO APPLICATIONS and Patent Cooperation Treaty Application No. PCT/US11/63587, filed Dec. 6, 2011, entitled ENHANCED SLOT-MACHINE FOR CASINO APPLICATIONS each disclosure of which is hereby incorporated by reference in its entirety.

In many embodiments, a hockey themed hybrid game integrates a hockey themed entertainment game with a gambling game. In several embodiments, a hockey themed hybrid game can utilize a GWE to monitor hockey themed entertainment game gameplay executed by an ESE for a gambling event occurrence. The gambling event occurrence can be detected from the skillful execution of the hockey themed entertainment game in accordance with at least one gambling event occurrence rule. The gambling event occurrence can be communicated to a RWE, where the gambling event occurrence triggers a wager made in accordance with a wager execution rule within the gambling game executed by the RWE. The wager can produce a wager payout as a randomly generated payout of gameplay resources. A hockey themed entertainment game gameplay modification can be generated by the GWE that can be used to modify hockey themed entertainment game gameplay executed by the ESE based upon the wager payout. In various embodiments, hockey themed entertainment game gameplay can advance through the performance of hockey themed player actions, where a hockey themed player action is an action during hockey themed hybrid game gameplay that can be performed by a player or to a player.

In several embodiments, a gambling event occurrence can be any occurrence within a hockey themed entertainment game used to trigger a wager in a gambling game. A gambling event occurrence can include, but is not limited to, passage of a period of time during hockey themed entertainment game gameplay, a result from a hockey themed entertainment game gameplay session (such as but not limited to a goal or a particular score), a player action that is a consumption of an element, or a player action that achieves a combination of elements to be associated with a player profile.

In numerous embodiments, an entertainment game modification is an instruction of how to modify hockey themed entertainment game gameplay based upon a wager payout. An entertainment game modification can modify any aspect of a hockey themed entertainment game, such as but is not limited to an addition of a period of time available for a current hockey themed entertainment game gameplay session, an addition of a period of time available for a future hockey themed entertainment game gameplay session or any other modification to elements that can be utilized in hockey themed entertainment game gameplay. In certain embodiments, an entertainment game modification can modify a type of element whose consumption is a gambling event occurrence. In particular embodiments, an entertainment game modification can modify a type of element whose consumption is not required in a gambling event occurrence.

In a number of embodiments, a user interface can be utilized that depicts a status of the hockey themed entertainment game. A user interface can depict any aspect of a hockey themed entertainment game including, but not limited to, an illustration of hockey themed entertainment game gameplay advancement by maneuvering an object with a stick into an opponent's goal.

Hockey themed hybrid games in accordance with embodiments of the invention are discussed below.

### Hockey Themed Hybrid Games

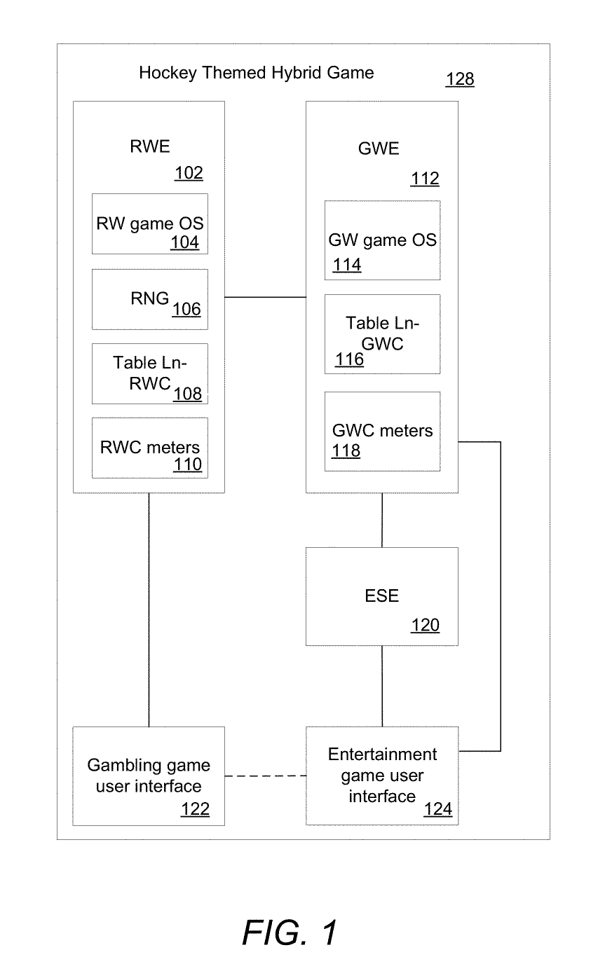

In many embodiments, a hockey themed hybrid game integrates high-levels of entertainment content with a game of skill (hockey themed entertainment game) and a gambling experience with a game of chance (gambling game). A hockey themed hybrid game provides for random outcomes independent of player skill while providing that the user's gaming experience (as measured by obstacles/challenges encountered, time of play and other factors) is shaped by the player's skill. A hockey themed hybrid game in accordance with an embodiment of the invention is illustrated in FIG. 1. The hockey themed hybrid game 128 includes a RWE 102, GWE 112, ESE 120, gambling game user interface 122 and hockey themed entertainment game user interface 124. The two user interfaces can be part of the same user interface but are separate in the illustrated embodiment. The RWE 102 is connected with the GWE 112 and the gambling game user interface 122. The ESE 120 is connected with the GWE 112 and the hockey themed entertainment game user interface 124. The GWE 112 is connected also with the hockey themed entertainment game user interface 124.

In several embodiments, the RWE 102 is the operating system for the gambling game of the hockey themed hybrid game 128 and controls and operates the gambling game. The operation of a gambling game is enabled by RWC, such as money or other real world funds. A gambling game can increase or decreases an amount of RWC based on random gambling outcomes, where the gambling proposition of a gambling game is typically regulated by gaming control bodies. In many embodiments, the RWE includes a RW operating system (OS) 104, random number generator (RNG) 106, level n real-world credit pay tables (table Ln-RWC) 108, RWC meters 110 and other software constructs that enable a game of chance to offer a fair and transparent gambling proposition, and to contain the auditable systems and functions that can enable the game to obtain gaming regulatory body approval.

A random number generator (RNG) 106 includes software and/or hardware algorithms and/or processes, which are used to generate random outcomes. A level n real-world credit pay table (table Ln-RWC) 108 is a table that can be used in conjunction with a random number generator (RNG) 106 to dictate the real world credits (RWC) earned as a function of hockey themed hybrid game gameplay and is analogous to the pay tables used in a conventional slot machine. table Ln-RWC payouts are independent of player skill. There can be one or a plurality of table Ln-RWC pay tables 108 contained in a gambling game, the selection of which can be determined by factors including (but not limited to) game progress a player has earned, and/or bonus rounds which a player can be eligible for. Real world credits (RWC) are credits analogous to slot machine game credits, which are entered into a gambling game by the user, either in the form of money such as hard currency or electronic funds. RWCs can be decremented or augmented based on the outcome of a random number generator according to the table Ln-RWC real world credits pay table 108, independent of player skill. In certain embodiments, an amount of RWC can be used as criteria in order to enter higher hockey themed entertainment game levels. RWC can be carried forward to higher game levels or paid out if a cash out is opted for by a player. The amount of RWC used to enter a specific level of the game level n need not be the same for each level.

In many embodiments, the GWE 112 manages the overall hockey themed hybrid game operation, with the RWE 102 and the ESE 120 effectively being support units to the GWE 112. In several embodiments, the GWE 112 contains mechanical, electronic and software system for a hockey themed entertainment game. The GWE 112 includes an operating system (OS) 114 that provides control of the hockey themed entertainment game. The GWE additionally contains a level n game world credit pay table (table Ln-GWC) 116 from where to take input from this table to affect the play of the hockey themed entertainment game. The GWE 112 can further couple to the RWE 102 to determine the amount of RWC available on the game and other metrics of wagering on the gambling game (and potentially affect the amount of RWC in play on the RWE). The GWE additionally contains various audit logs and activity meters (such as the GWC meter) 118. The GWE 112 can also couple to a centralized server for exchanging various data related to the player and their activities on the game. The GWE 112 furthermore couples to the ESE 120.

In many embodiments, a level n game world credit pay table (table Ln-GWC) 116 dictates the GWC earned as a function of player skill in the nth level of the game. The payouts governed by this table are dependent upon player skill and hockey themed hybrid game gameplay at large and can or cannot be coupled to a random number generator. In several embodiments, game world credits (GWC) are player points earned or depleted as a function of player skill, specifically as a function of player performance in the context of the game. GWC is analogous to the score in a typical video game. A hockey themed entertainment game can have one or more scoring criterion, embedded within the table Ln-GWC 116 that reflects player performance against the goal(s) of the hockey themed entertainment game. GWC can be carried forward from one level of sponsored gameplay to another, and ultimately paid out in various manners such as directly in cash, or indirectly such as by earning entrance into a sweepstakes drawing, or earning participation in, or victory in, a tournament with prizes. GWC can be stored on a player tracking card or in a network-based player tracking system, where the GWC is attributed to a specific player.

In certain embodiments, the operation of the GWE does not affect the RWE's gambling operation except for player choice parameters that are allowable in slot machines including but not limited to wager terms such as but not limited to a wager amount, how fast the player wants to play (by pressing a button or pulling the handle of a slot machine) and/or agreement to wager into a bonus round. In this sense, the RWE 102 provides a fair and transparent, non-skill based gambling proposition co-processor to the GWE 112. In the illustrated embodiment, the communication link shown between the GWE 112 and the RWE 102 allows the GWE 112 to obtain information from the RWE 102 as to the amount of RWC available in the gambling game. The communication link can also convey a status operation of the RWE (such as on-line or tilt). The communication link can further communicate the various gambling control factors which the RWE 102 uses as input, such as the number of RWC consumed per game or the player's election to enter a jackpot round. In FIG. 1, the GWE 112 is also shown as connecting to the player's user interface directly, as this can be utilized to communicate certain hockey themed entertainment game club points, player status, control the selection of choices and messages which a player can find useful in order to adjust the a hockey themed entertainment game experience or understand their gambling status in the RWE 102.

In various embodiments, the ESE 120 manages and controls the visual, audio, and player control for the hockey themed entertainment game. In certain embodiments, the ESE 120 accepts input from a player through a set of hand controls, and/or head, gesture, and/or eye tracking systems and outputs video, audio and/or other sensory output to a user interface. In many embodiments, the ESE 120 can exchange data with and accept control information from the GWE 112. In several embodiments an ESE 120 can be implemented using a personal computer (PC), a Sony PlayStation® (a video game console developed by Sony Computer Entertainment of Tokyo Japan), or Microsoft Xbox® (a video game console developed by Microsoft Corporation of Redmond, Wash.) running a specific entertainment game software program. In numerous embodiments, an ESE can be an electromechanical game system of a hockey themed hybrid game that is an electromechanical hybrid game. An electromechanical hybrid game executes an electromechanical game for player entertainment. The electromechanical game can be any game that utilizes both mechanical and electrical components, where the game operates as a combination of mechanical motions performed by at least one player or the electromechanical game itself. Various electromechanical hybrid games are discussed in Patent Cooperation Treaty Application No. PCT/US12/58156, filed Sep. 29, 2012, the contents of which are hereby incorporated by reference in their entirety.

The ESE 120 operates mostly independently from the GWE 112, except that via the interface, the GWE 112 can send certain a hockey themed entertainment game control parameters to the ESE 120 to affect its play, such as (but not limited to) what level of character to be using, changing the difficulty level of the game, changing the type of team in use, and/or weather conditions on the playing field. These game control parameters can be based on a gambling outcome of a gambling game that was triggered by an element in the hockey themed entertainment game being acted upon by the player. The ESE 120 can accept this input from the GWE 112, make adjustments, and continue hockey themed entertainment game gameplay all the while running seamlessly from the player's perspective. The ESE's operation is mostly skill based, except for where the ESE's processes can inject complexities into the game by chance in its normal operation to create unpredictability in the hockey themed entertainment game. Utilizing this interface, the ESE 120 can also communicate player choices made in the game to the GWE 112, such as but not limited to selection of a hockey character, hockey team, hockey puck, hockey ball or hockey stick in the hockey themed entertainment game. The GWE's job in this architecture, being interfaced thusly to the ESE 120, is to allow the transparent coupling of an hockey themed entertainment game to a fair and transparent random chance gambling game, providing a seamless perspective to the player that they are playing a typical popular hockey themed entertainment game (which is skill based).

In several embodiments, the RWE 102 can accept a trigger to run a gambling game in response to actions taken by the player in the hockey themed entertainment game as conveyed by the ESE 120 to the GWE 112, or as triggered by the GWE 112 based on its algorithms, background to the overall hybrid game from the player's perspective, but can provide information to the GWE 112 to expose the player to certain aspects of the gambling game, such as (but not limited to) odds, amount of RWC in play, and amount of RWC available. The RWE 102 can accept modifications in the amount of RWC wagered on each individual gambling try, or the number of gambling games per minute the RWE 102 can execute, entrance into a bonus round, and other factors, all the while these factors can take a different form than that of a typical slot machine. An example of a varying wager amount that the player can choose can include but is not limited to gameplay with a more powerful character or a more skillful team. These choices can increase or decrease the amount wagered per individual gambling game, in the same manner that a standard slot machine player can decide to wager more or less credits for each pull of the handle. In several embodiments, the RWE 102 can communicate a number of factors back and forth to the GWE 112, via an interface, such that an increase/decrease in a wagered amount can be related to the player's decision making as to their player profile in the hockey themed entertainment game (such as but not limited to the power of the character, hockey stick selection or hockey team choice). In this manner, a player can be in control of a per game wager amount, with the choice mapping to a parameter or component that is applicable to the hockey themed entertainment game experience. In a particular embodiment, the RWE 102 operation can be a game of chance as a gambling game running every 10 seconds where the amount wagered is communicated from the GWE 112 as a function of choices the player makes in the player's player profile in the hockey themed entertainment game.

In many embodiments, a hockey themed hybrid game integrates a video game style gambling machine, where the gambling game (including an RWE 102 and RWC) is not player skill based, while at the same time allows players to use their skills to earn club points which a casino operator can translate to rewards, tournament opportunities and prizes for the players. The actual exchange of monetary funds earned or lost directly from gambling against a game of chance in a gambling game, such as a slot machine, is preserved. At the same time a rich environment of rewards to stimulate gamers can be established with the entertainment game. In several embodiments, the hockey themed hybrid game can leverage popular titles with gamers and provides a sea change environment for casinos to attract players with games that are more akin to the type of entertainment that a younger generation desires. In various embodiments, players can use their skill towards building and banking GWC that in turn can be used to win tournaments and various prizes as a function of their gamer prowess. Numerous embodiments minimize the underlying changes applied to the aforementioned entertainment software for the hybrid game to operate within a hockey themed entertainment game construct. Therefore, a plethora of complex game titles and environments can be rapidly and inexpensively to deployed in a gambling environment.

In certain embodiments, hockey themed hybrid games also allow players to gain entry into subsequent competitions through the accumulation of game world credits (GWC) as a function of the user's demonstrated skill at the game. These competitions can pit individual players or groups of players against one another and/or against the operator of a gambling game (such as but not limited to a casino) to win prizes based upon a combination of chance and skill. These competitions can be either asynchronous events, whereby players participate at a time and/or place of their choosing, or they can be synchronized events, whereby players participate at a specific time and/or venue.

In many embodiments, one or more players can be engaged in playing a skill based hockey themed entertainment game executed by the ESE. A hockey themed hybrid game can include an entertainment game that includes head to head play between a single player and the computer, between two or more players against one another, or multiple players playing against the computer and/or each other, as well as a process by which player can bet on the outcome of an hockey themed entertainment game. The hockey themed entertainment game can also be a game where the player is not playing against the computer or any other player, such as in games where the player is effectively playing against himself or herself.

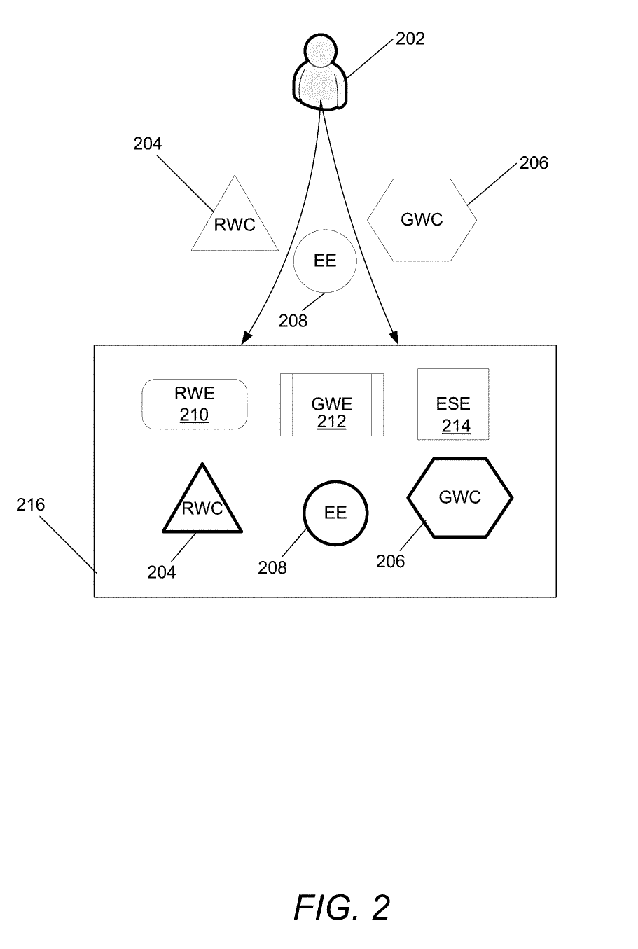

In several embodiments, a player can interact with a hockey themed hybrid game by using RWC in interactions with a gambling game along with GWC and elements in interactions with a hockey themed entertainment game. The gambling game can be executed by a RWE while a hockey themed entertainment game can be executed with an ESE and managed with a GWE. A conceptual diagram that illustrates how resources such as GWC, RWC and elements, such as but not limited to EE, are utilized in a hockey themed hybrid game in accordance with an embodiment of the invention is illustrated in FIG. 2. The conceptual diagram illustrates that RWC 204, EE 208 and GWC 206 can be utilized by a player 202 in interactions with the RWE 210, GWE 212 and ESE 214 of a hockey themed hybrid game 216. The contribution of elements, such as EE 208, can be linked to a player's access to credits, such as RWC 204 or GWC 206. Electronic receipt of these credits can come via a smart card, voucher or other portable media, or as received over a network from a server. In certain implementations, these credits can be drawn on demand from a player profile located in a database locally on a hockey themed hybrid game or in a remote server.

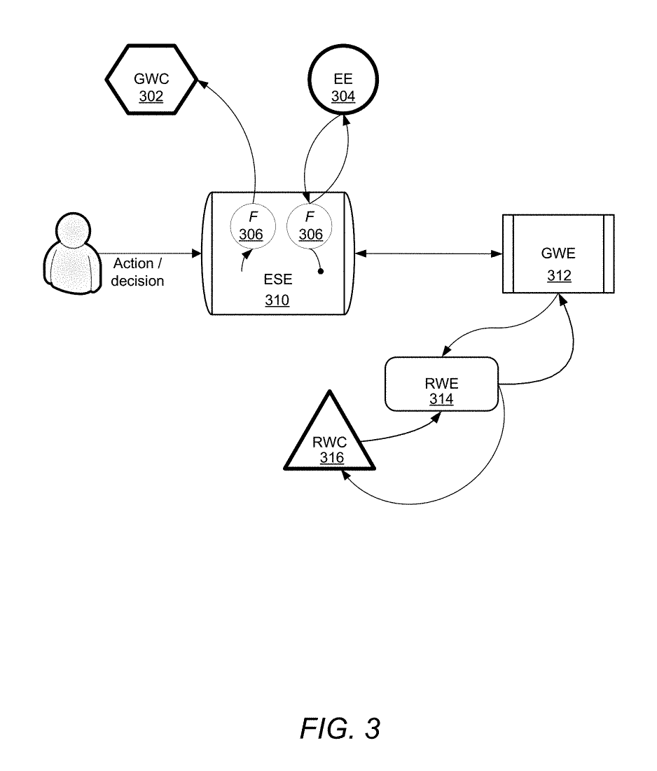

A conceptual diagram that illustrates interplay between elements and components of a hockey themed hybrid game in accordance with an embodiment of the invention is illustrated in FIG. 3. Similar to FIG. 2, a player's actions and/or decisions can affect functions 306 that consume and/or accumulate GWC 302 and/or EE 304 in a hockey themed entertainment game executed by an ESE 310. A GWE 312 can monitor the activities taking place within a hockey themed entertainment game executed by an ESE 310 for gameplay gambling event occurrences. The GWE 312 can also communicate the gameplay gambling event occurrences to an RWE 314 that triggers a wager of RWC 316 in a gambling game executed by the RWE 314.

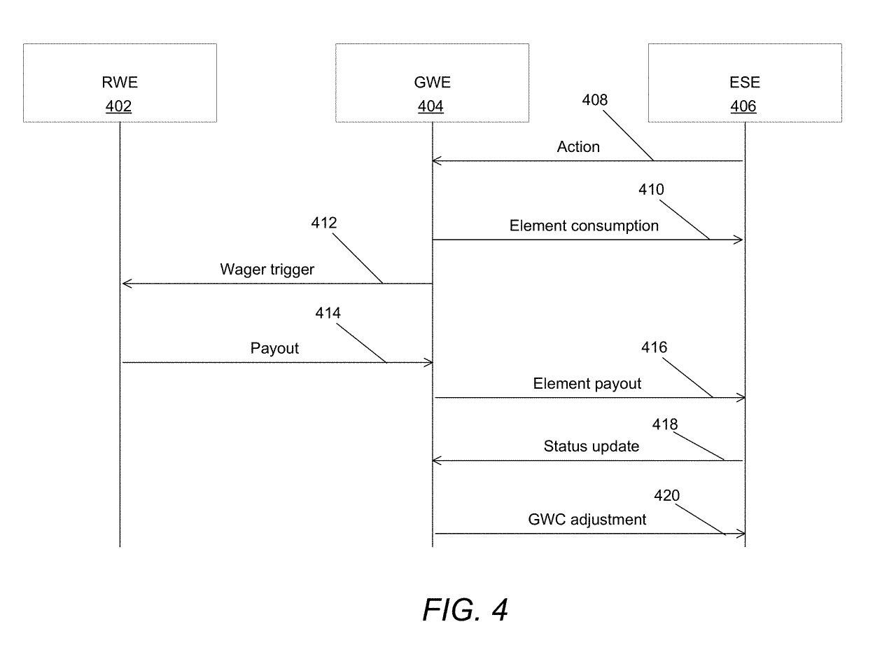

A timing diagram that illustrates a process of facilitating interactions between a hockey themed entertainment game and a gambling game in accordance with embodiments of the invention is illustrated in FIG. 4. The process includes a player performing a player action using a user interface. An ESE 406 can signal (408) a GWE 404 of the player action. The GWE 404 can signal (410) the ESE 406 as to the amount of EE that will be consumed by the player action in return. The signal can configure a function that controls EE consumption, decay or addition for the ESE. The ESE 406 can, based upon the function, consume an amount of EE designated by the GWE 404 to couple to the activity. Upon detection that the player action is a gameplay gambling event, the GWE 404 can signal an RWE 402 as to the wager terms associated with the gameplay gambling event in a triggered (412) wager. The RWE 402 can consume RWC in executing the wager. The RWE 402 can return RWC as a payout from the wager. The RWE 402 can inform (414) the GWE 404 as to the payout from the wager. The GWE 404 can signal (416) the ESE 406 to ascribe a payout of EE based upon the wager. The ESE 406 can reconcile and combine the payout of EE with the EE already ascribed to the player in the hockey themed entertainment game. The ESE 406 can signal (408) the GWE 404 as to its updated status based upon reconciling the payout of EE, and the GWE 404 can signal the ESE 406 of a payout of GWC in response (420) to the status update.

In certain embodiments, the sequence of events in the timing diagram of FIG. 4 can be reflected in a first person hockey themed entertainment game. For example, a player can select a hockey stick to use in an entertainment game and shoot pucks into an opponent's goal. The ESE can signal (408) the GWE of the player action, such as but not limited to signaling the GWE as to the player's choice of hockey stick, that a shot was made to the opponent's goal, and the outcome of whether the player scored. The GWE can process the information concerning the shot to the opponent's goal, and signal (410) the ESE to consume a puck (EE) with each shot to the opponent's goal. The entertainment game then will consume a puck (EE) based upon the shot to the opponent's goal. The GWE can also signal (412) the RWE that 3 credits of RWC are to be wagered to match the 1 puck (EE) consumed, on a particular pay table (table Ln-RC) as a function how much GWC is deducted from the opponent due to the shot to the opponent's goal. The RWE can consume the 3 credits for the wager and execute the specified wager. In executing the wager, the RWE can determine that the player hits a jackpot of 6 credits, and allocate the 6 credits of RWC to the credit meter. The RWE can also inform (414) the GWE that 6 credits of RWC net were won as a payout from the wager. The GWE can signal (416) the ESE to add 2 pucks (EE) to the number of pucks available to a player based upon the gambling game payout. The ESE can then add 2 pucks (EE) to the number of pucks available to a player in the hockey themed entertainment game. The GWE can receive (418) an update from the ESE as to the total amount of EE associated with the player. The GWE can log the new player score (GWC) in the game (as a function of the successful shot to the opponent's goal) based on the update, and signal (420) the ESE to add 2 extra points of GWC to the player's score.

In many embodiments, a player can bet on whether or not the player will beat another player. These bets can be made, for example, on the final outcome of the game, and/or the state of the game along various intermediary points (such as but not limited to the score at the end of the 1st period of a hockey themed entertainment game session) and/or on various measures associated with the game. Players can bet against one another, or engage the computer in a head to head competition in the context of their skill level in the hockey themed entertainment game in question. As such, players can have a handicap associated with their player profile that describes their skill (which can be their professed skill in certain embodiments), and which is used by a GWE (such as a local GWE or a GWE that receives services from remote servers) to offer appropriate bets around the final and/or intermediate outcomes of the hockey themed entertainment game, and/or to condition sponsored gameplay as a function of player skill, and/or to select players across one or more hockey themed hybrid games to participate in head to head games and/or tournaments.

Many embodiments enable the maximization of the number of players able to compete competitively by enabling handicapping of players by utilizing a skill normalization module that handicaps players to even the skill level of players competing against each other. Handicapping enables players of varying performance potential to compete competitively regardless of absolute skill level, such as but not limited to where a player whose skill level identifies the player as a beginner can compete in head to head or tournament play against a highly skilled player with meaningful results.

In several embodiments, wagers can be made among numerous hockey themed hybrid games with a global betting manager (GBM). The GBM is a system that coordinates wagers that are made across multiple hockey themed hybrid games by multiple players. In some implementations it can also support wagers by third parties relative to the in game performance of other players. The GBM can stand alone, or is capable of being embedded in one of a number of systems, including a GWE, ESE or any remote server capable of providing services to a hockey themed hybrid game, or can operate independently on one or a number of servers on-site at a casino, as part of a larger network and/or the Internet or cloud in general.

Although various components of hockey themed hybrid games are discussed above, hockey themed hybrid games can be configured with any component as appropriate to the specification of a specific application in accordance with embodiments of the invention. In certain embodiments, components of a hockey themed hybrid game, such as a GWE, RWE, ESE can be configured in different ways for a specific hockey themed hybrid game gameplay application. Network connected hockey themed hybrid games are discussed below.

### Network Connected Hockey Themed Hybrid Games

Hockey themed hybrid games in accordance with many embodiments of the invention can operate locally while being network connected to draw services from remote locations or to communicate with other hockey themed hybrid games. In many embodiments, operations associated with a hockey themed hybrid game utilizing a hockey themed entertainment game can be performed across multiple devices. These multiple devices can be implemented using a single server or a plurality of servers such that a hockey themed hybrid game is executed as a system in a virtualized space, such as (but not limited to) where the RWE and GWE are large scale centralized servers in the cloud coupled to a plurality of widely distributed ESE controllers or clients via the Internet.

In many embodiments, a RWE server can perform certain functionalities of a RWE of a hockey themed hybrid game. In certain embodiments, a RWE server includes a centralized odds engine which can generate random outcomes (such as but not limited to win/loss outcomes) for a gambling game. The RWE server can perform a number of simultaneous or pseudo-simultaneous runs in order to generate random outcomes for a variety of odds percentages that one or more networked hockey themed hybrid games can use. In certain embodiments, an RWE of a hockey themed hybrid game can send information to a RWE server including (but not limited to) table Ln-RWC tables, maximum speed of play for a gambling game, gambling game monetary denominations or any promotional RWC provided by the operator of the hockey themed hybrid game. In particular embodiments, a RWE server can send information to a RWE of a hockey themed hybrid game including (but not limited to) RWC used in the gambling game, player profile information or play activity and a profile associated with a player.

In several embodiments, a GWE server can perform the functionality of the GWE across various hockey themed hybrid games. These functionalities can include (but are not limited to) providing a method for monitoring high scores on select groups of games, coordinating interactions between gameplay layers, linking groups of games in order to join them in head to head tournaments, and acting as a tournament manager.

In a variety of embodiments, management of player profile information can be performed by a patron management server separate from a GWE server. A patron management server can manage information related to a player profile, including (but not limited to) data concerning controlled entities (such as characters used by a player in hockey themed entertainment game gameplay), game scores, elements, RWC and GWC associated with particular players and managing tournament reservations. Although a patron management server is discussed separate from a GWE server, in certain embodiments a GWE server also performs the functions of a patron management server. In certain embodiments, a GWE of a hockey themed hybrid game can send information to a patron management server including (but not limited to) GWC and RWC used in a game, player profile information, play activity and profile information for players and synchronization information between a gambling game and a hockey themed entertainment game or other aspects of a hockey themed hybrid game. In particular embodiments, a patron management server can send information to a GWE of a hockey themed hybrid game including (but not limited to) hockey themed entertainment game title and type, tournament information, table Ln-GWC tables, special offers, character or profile setup and synchronization information between a gambling game and an hockey themed entertainment game or other aspects of a hockey themed hybrid game.

In numerous embodiments, an ESE server provides a host for managing head to head play, operating on the network of ESEs which are connected to the ESE server by providing an environment where players can compete directly with one another and interact with other players. Although an ESE server is discussed separate from a GWE server, in certain embodiments the functionalities of an ESE server and GWE server can be combined in a single server.

Servers connected via a network to implement hockey themed hybrid games in accordance with many embodiments of the invention can communicate with each other to provide services utilized by a hockey themed hybrid game. In several embodiments a RWE server can communicate with a GWE server. A RWE server can communicate with a GWE server to communicate any type of information as appropriate for a specific application, including (but not limited to): information used to configure the various simultaneous or pseudo simultaneous odds engines executing in parallel within the RWE to accomplish hockey themed hybrid game system functionalities, information used to determine metrics of RWE performance such as random executions run and outcomes for tracking system performance, information used to perform audits, provide operator reports, and information used to request the results of a random run win/loss result for use of function operating within the GWE (such as where automatic drawings for prizes are a function of ESE performance).

In several embodiments a GWE server can communicate with an ESE server. A GWE server can communicate with an ESE server to communicate any type of information as appropriate for a specific application, including (but not limited to): the management of an ESE server by a GWE server during a hockey themed hybrid game tournament. Typically a GWE (such as a GWE that runs within a hockey themed hybrid game or on a GWE server) is not aware of the relationship of itself to the rest of a tournament since in a typical configuration the actual tournament play is managed by the ESE server. Therefore, management of a hockey themed hybrid game tournament can include (but is not limited to) tasks such as: conducting tournaments according to system programming that can be coordinated by an operator of the hockey themed hybrid game; allowing entry of a particular player into a tournament; communicating the number of players in a tournament and the status of the tournament (such as but not limited to the amount of surviving players, their status within the game, time remaining on the tournament); communicating the performance of its players within the tournament; communicating the scores of the various members in the tournament; and providing a synchronizing link to connect the GWEs in a tournament with their respective ESEs.

In several embodiments a GWE server can communicate with a patron management server. A GWE server can communicate with a patron management server to communicate any type of information as appropriate for a specific application, including (but not limited to) information for configuring tournaments according to system programming conducted by an operator of a hockey themed hybrid game, information for exchange of data used to link a player's player profile to their ability to participate in various forms of hockey themed hybrid game gameplay (such as but not limited to the difficulty of play set by the GWE server or the GWE), information for determining a player's ability to participate in a tournament as a function of a player's characteristics (such as but not limited to a player's gaming prowess or other metrics used for tournament screening), information for configuring GWE and ESE performance to suit preferences of a player on a particular hockey themed hybrid game, information for determining a player's play and gambling performance for the purposes of marketing intelligence, and information for logging secondary drawing awards, tournament prizes, RWC and GWC into the player profile.

In many embodiments, the actual location of where various algorithms and functions are executed can be located either in the game contained devices (RWE, GWE, ESE), on the servers (RWE server, GWE server, or ESE server), or a combination of both game contained devices and servers. In particular embodiments, certain functions of a RWE server, GWE server, patron management server or ESE server can operate on the local RWE, GWE or ESE contained with a hockey themed hybrid game locally. In certain embodiments, a server can be part of a server system including a plurality of servers, where software can be run on one or more physical devices. Similarly, in particular embodiments, multiple servers can be combined on a single physical device.

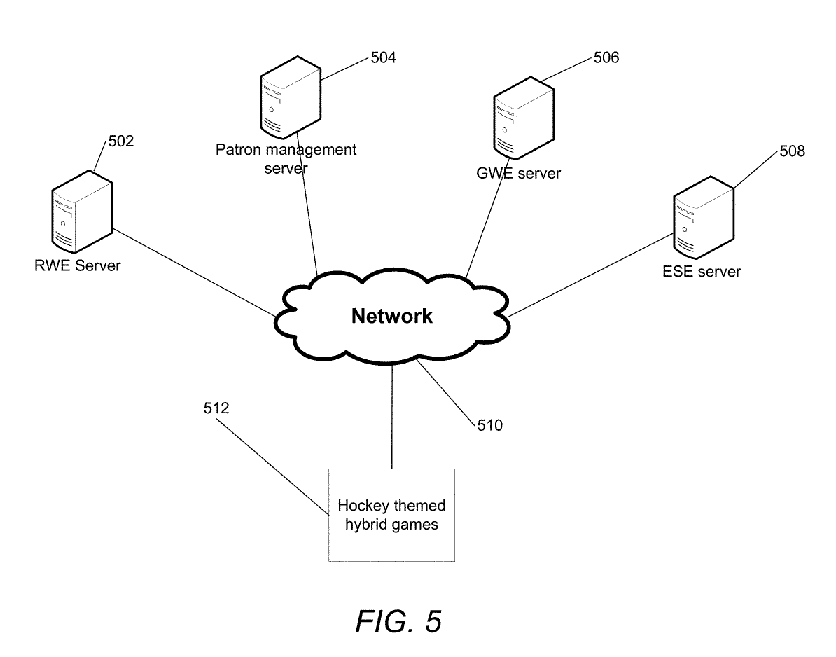

Hockey themed hybrid games in accordance with many embodiments of the invention can be networked with remote servers in various configurations. A networked hockey themed hybrid game in accordance with an embodiment of the invention is illustrated in FIG. 5. The networked hockey themed hybrid game 512 is connected with a RWE server 502, patron management server 504, GWE server 506, ESE server 508 and a hockey themed hybrid game server 514 over a network 510, such as (but not limited to) the Internet. Servers networked with a networked hockey themed hybrid game 512 can also communicate with each of the components of a networked hockey themed hybrid game and amongst the other servers in communication with the networked hockey themed hybrid game 512.

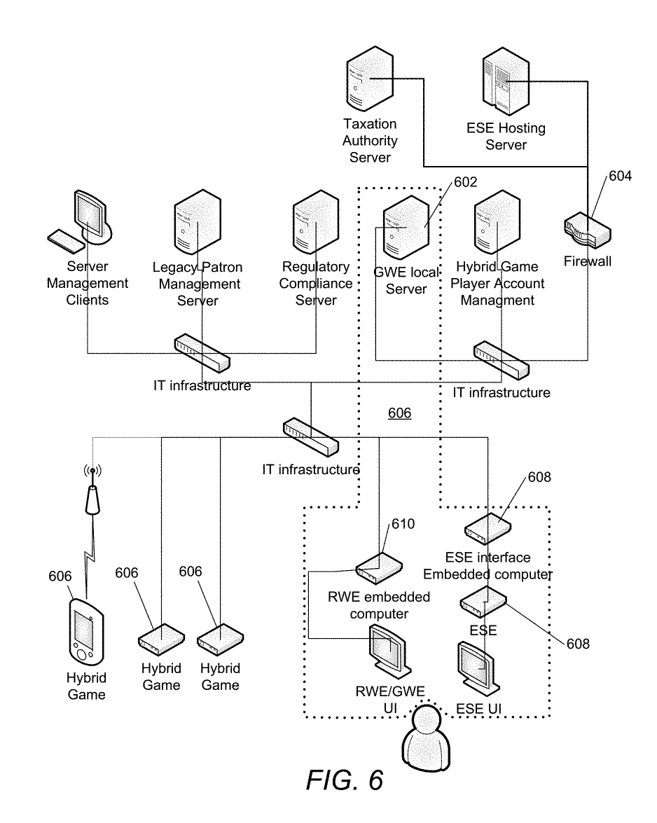

A system diagram that illustrates an implementation of a network distributed hockey themed hybrid game with a GWE local server in accordance with an embodiment of the invention is illustrated in FIG. 6. The system includes several hockey themed hybrid games 606 sharing services from the same GWE local server 602 over a network. The several hockey themed hybrid games can be implemented on any device, including laptops, desktop computers, mobile phones, tablets over a wireless connection. A single hockey themed hybrid game 606 with a RWE 610, ESE 608 and GWE 602 is enclosed within a dotted line. A number of other peripheral systems, such as player management, casino management, regulatory, and hosting servers can also interface with the hockey themed hybrid games over a network within an operator's firewall 604. Also, other servers can reside outside the bounds of a network within an operator's firewall 604 to provide additional services for network connected hockey themed hybrid games.

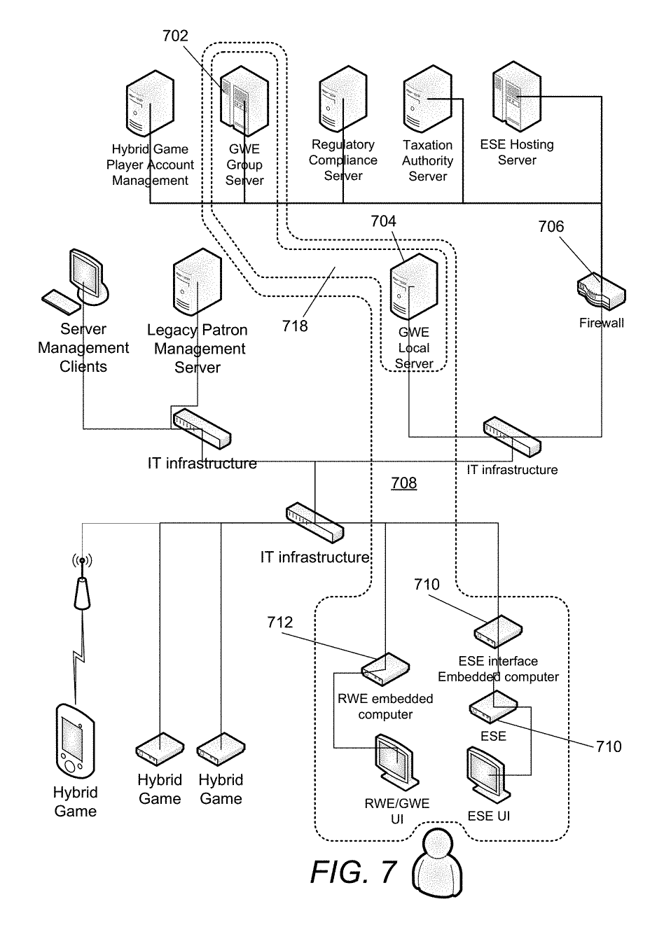

A system diagram that illustrates an implementation of a network distributed hybrid game with a GWE local server and a GWE group server in accordance with an embodiment of the invention is illustrated in FIG. 7. This system includes a hockey themed hybrid game with a RWE 712, ESE 710 and GWE local server 704 enclosed within a dotted line but where a single hybrid game can call upon services from servers within an operator's firewall 706 (such as but not limited to a GWE local server) as well as beyond an operator's firewall 706 (such but not limited to a GWE group server 702). The GWE group server 702 can coordinate multiple hockey themed hybrid games from across a network that spans beyond an operator's firewall 706. A GWE server system 718 can include multiple GWE servers, such as but not limited to a GWE local server 704 and a GWE group server 702. Multiple network connected hybrid games can be implemented using various computing devices (such as but not limited to laptops, desktop computers, mobile phones, PDAs or tablets) and be connected to various servers to call upon services that enable the execution of the hybrid game.

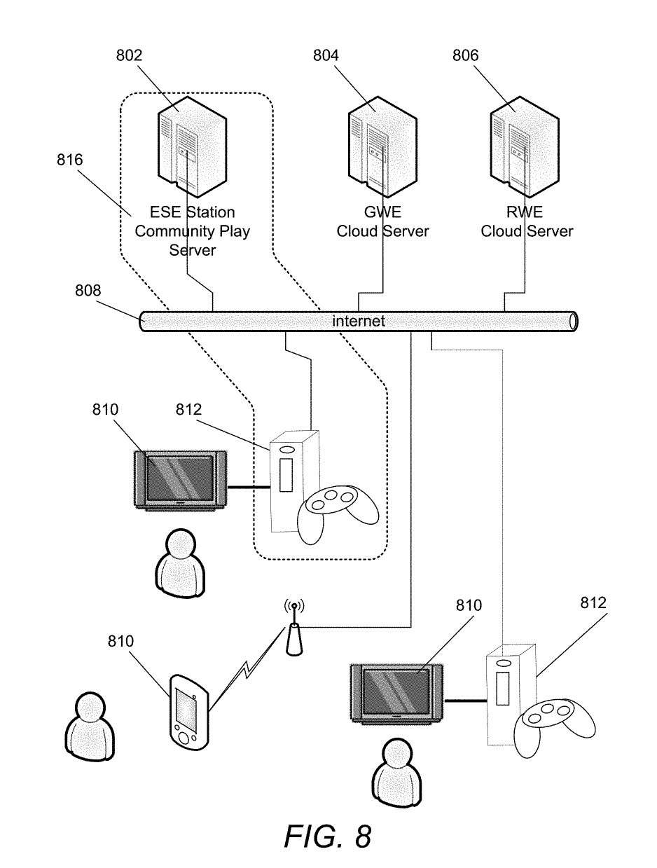

A system diagram that illustrates an implementation of network distributed hybrid games over the Internet in accordance with an embodiment of the invention is illustrated in FIG. 8. The system includes an ESE server 802, GWE server 804 and RWE server 806 that connects to a user interface 810 (such as but not limited to a television screen, computer terminal, tablet, touchscreen or PDA) of hockey themed hybrid games over the Internet 808. Each hockey themed hybrid game includes a local ESE 812 that also interfaces with a remote ESE server 802. In certain embodiments, the user interface and local ESE are combined in a single device. Processes performed by an ESE 816 can be performed in multiple locations, such as but not limited to remotely on an ESE server 802 and locally on a local ESE 812.

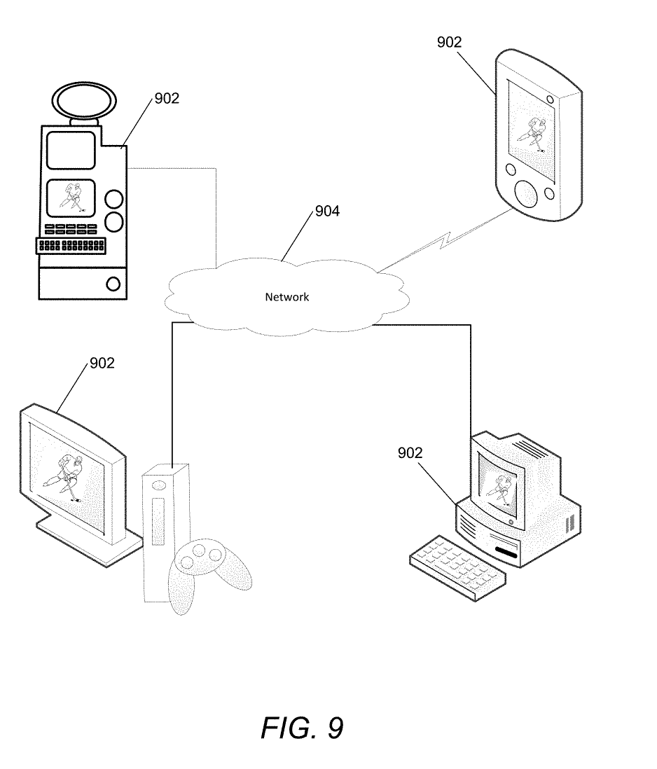

In numerous embodiments, a network distributed hockey themed hybrid game can be implemented on multiple different types of devices connected together over a network. Any type of device can be utilized in implementing a network distributed hockey themed hybrid game, such as but not limited to a gaming cabinet as used in a traditional land-based casino or a mobile computing device (such as but not limited to a PDA, smartphone, tablet computer or laptop computer), a game console (such as but not limited to a Sony PlayStation®, or Microsoft Xbox®) or on a Personal Computer (PC). Each of the devices may be operatively connected to other devices or other systems of devices via a network for the playing of head-to-head games. A system diagram that illustrates an implementation of a network distributed hockey themed hybrid game on multiple devices in accordance with an embodiment of the invention is illustrated in FIG. 9. The network distributed hockey themed hybrid game includes multiple hockey themed entertainment games of a hockey themed hybrid game executing on different types of devices 902 and connected together over a network 904.

Although various networked hockey themed hybrid games are discussed above, hockey themed hybrid games can be networked in any configuration as appropriate to the specification of a specific application in accordance with embodiments of the invention. In certain embodiments, components of a networked hockey themed hybrid game, such as a GWE, RWE, ESE or servers that perform services for a GWE, RWE or ESE, can be networked in different configurations for a specific networked hockey themed hybrid game gameplay application. Hockey themed hybrid game implementations are discussed below.

### Hockey Themed Hybrid Game Implementations

In several embodiments, a hockey themed hybrid game can be implemented as a hockey themed entertainment game with an associated gambling game. A hockey themed entertainment game can be an entertainment game with gameplay progression dependent upon a virtual character that uses a stick in maneuvering an object into an opponent's goal within the game to score points. A hockey themed entertainment game can be reflective of any version of hockey, such as but not limited to ice hockey, field hockey, roller hockey, or street hockey. A player of a hockey themed entertainment game can control a character as a CE that individually attempts to score on an opponent's goal or as a team that controls multiple CEs that individually attempt to score on an opponent's goal.

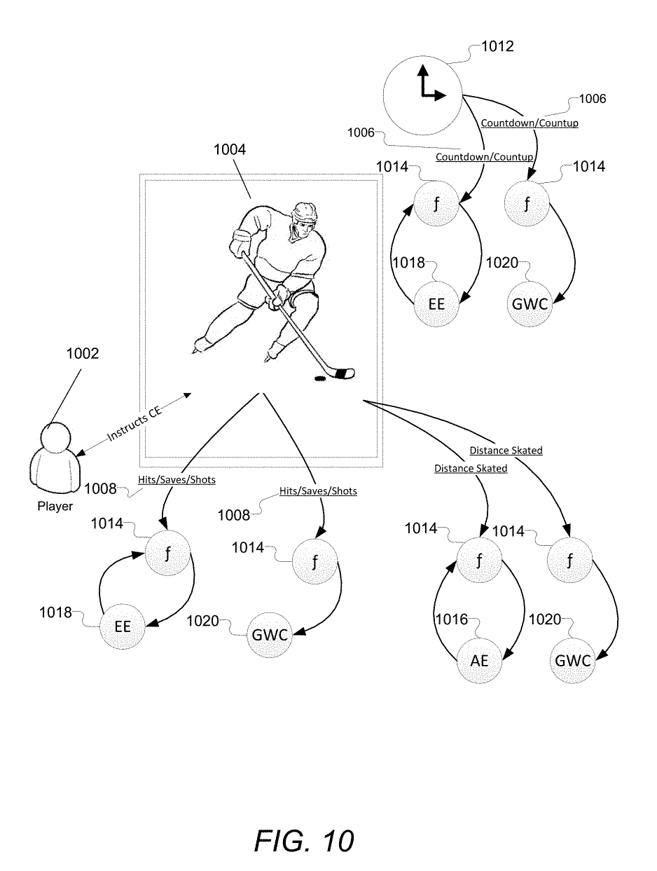

A conceptual diagram illustrating aspects of hockey themed entertainment game gameplay in accordance with an embodiment of the invention is illustrated in FIG. 10. The conceptual diagram illustrates that a player 1002 can instruct a CE 1104 to maneuver an object (such as but not limited to a puck or a ball) using a stick into an opponent's goal within the game. The entertainment game can be implemented by enabling the user to control the CE 1104 via a user interface that permits the user to provide instructions corresponding to the performance of various hockey themed player actions within the game, such as but not limited to hits of an object using a stick, saves made by maneuvering an object away from the CE's own goal or a shot made to maneuver an object into an opponent's goal. In many embodiments, hockey themed player actions can be measured using measurements including (but are not limited to) distance skated 1010 and/or time elapsed 1012 as a countdown/countup 1006 during hockey themed entertainment game gameplay. Each hockey themed player action 1008 (including but not limited to hits, saves, shots on goal) can be related to the set of hockey themed entertainment game variables that affects hockey themed entertainment game progression, such as an element (such as but not limited to EE or AE) or credits (such as but not limited to GWC or RWC). AE 1016, EE 1018, and/or GWC 1020 awarded may be a function 1014 of entertainment game variables and/or input from the RWE.

In several embodiments, hockey themed entertainment game gameplay can progress based upon the utilization of elements within the hockey themed entertainment game. In many embodiments, an element in a hockey themed entertainment game can include (but is not limited to) time. The time can be in any increment, such as but not limited to an amount of time allocated for a complete game of hockey, a period of a game of hockey (where a game of hockey is divided into several periods) or other aspects of a hockey themed entertainment game where time is consumed (such as but not limited to time taken for overtime, when a tie occurs between opposing teams). In certain embodiments, time can be ascribed to a player in exchange for allocating RWC from an associated player account (such as but not limited to a player purchasing a period, where the purchase of three periods enables a player to experience a complete game of hockey). In particular embodiments, the consumption of time (based upon time elapsing during a hockey themed entertainment game gameplay session) can be a gambling event occurrence that triggers a wager in a gambling game. In various embodiments, an entertainment game modification that affects time available in a hockey themed entertainment game gameplay session can be generated based upon a wager payout.

In numerous embodiments, an element in a hockey themed entertainment game can include (but is not limited to) a hockey themed player action that is available to a player in limited quantity. Any type of hockey themed player action can be used as an element including, but not limited to, a save performed by a player's goal keeper to keep an opponent from scoring in the player's goal or a shot at an opponent's goal. Elements that are hockey themed player actions 1008 can be associated with a specific player, team of players or CE that a player controls. In many embodiments, a hockey themed player action 1008 can be associated with a quality level which relates to the probability of success of a hockey themed player action such as but not limited to a high quality shot at an opponent's goal that has a high probability of scoring or a low quality shot that has a low probability of scoring. In particular embodiments, each element can also be an AE whose consumption is a gambling event occurrence. In a number of embodiments, an element can be associated with a player by being purchased, such as but not limited to a player purchasing time for hockey themed entertainment game gameplay.

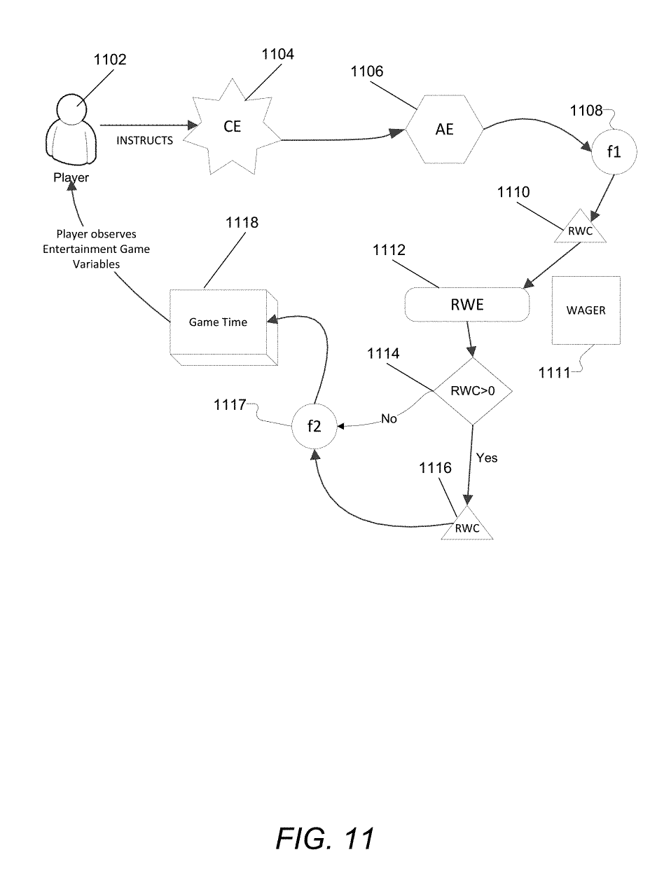

In many embodiments, a hockey themed hybrid game can initiate a wager based upon detection of a hockey themed player action. The wager payout resulting can be utilized in determining an entertainment game gameplay modification that instructs a hockey themed entertainment game to modify hockey themed entertainment game gameplay. A conceptual diagram illustrating how elements can be used to trigger a wager during hockey themed entertainment game gameplay in accordance with an embodiment of the invention is illustrated in FIG. 11. The conceptual diagram illustrates that a player 1102 can instruct a CE 1104 to perform a hockey themed player action that consumes an AE 1106. The function f1 1108, determines if the hockey themed player action that consumes an AE 1106 can be a gambling event occurrence that triggers a RWC 1110 wager 1111 executed by a RWE 1112 using an amount of RWC 1110 to yield a wager payout of RWC 1116 that is a positive value 1114. Function f2 1117, based upon input received from the wager payout (if any), generates an entertainment game gameplay modification, of elements 1118 available to a player (such as but not limited to increasing the time available) during a gameplay session of the hockey themed entertainment game.

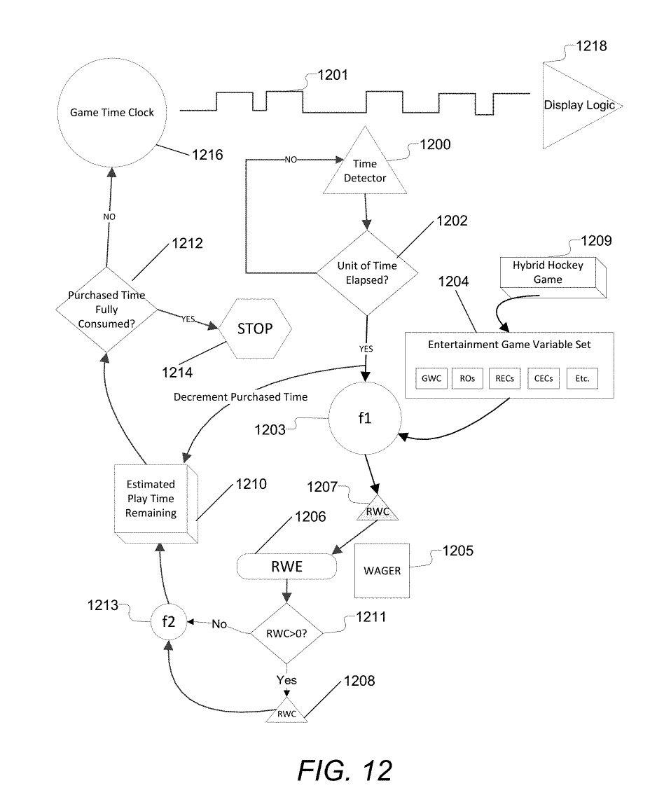

A conceptual diagram illustrating how elapsed time can be used to trigger a wager during hockey themed entertainment game gameplay in accordance with an embodiment of the invention is illustrated in FIG. 12. The process begins with a purchase of an amount of time available for a gameplay session of a hockey themed entertainment game (such as but not limited to by allocating 6 units of RWC from a player account, when each minute of time during a gameplay session consumes 0.1 units of RWC). The time detector 1200 monitors the output 1201 of the game time clock 1216. When the specified amount of time has elapsed 1202, the play time remaining 1210 is decremented accordingly, and a bet is triggered.

In various embodiments, once the specified unit of time has elapsed 1202, the function f1 1203 triggers a wager 1205 in the RWE 1206 by (1) determining the amount of RWC 1207 to be committed to the wager 1205, and then (2) communicating this to the RWE 1206.

In numerous embodiments, f1 1203 may also take into account the state, or changes in state of the entertainment game variable set 1204, of the hybrid hockey themed game 1209.

In various embodiments, once the wager takes place, if a winning result is achieved 1211, RWC 1208 is returned to the player.

In many embodiments, the amount of RWC 1208 generated (if any) also effects, via function f2 1213, game play variables, including but not limited to, play time remaining 1210 (for example, a winning wager may result in play time being added to the entertainment game).

In numerous embodiments, if play time remains, play continues. Once the play time is fully consumed 1212, a stop function 1214, may be invoked. When the stop function 1214 is invoked, the player may be given the option of adding additional play time, by committing additional RWC to the game.

In many embodiments, the amount of game time elapsed 1202 is not an argument to f1 1203, but enables f1 1203. f1 1203 may take as arguments, the entertainment game variable set 1204, either to affect the amount of RWC 1207 committed to the gambling game, and/or to affect the pay tables, and/or solely as conditions to be met before f1 1203 will invoke a wager, and establish the amount of RWC 1207 to be committed to the gambling game.

In many embodiments, the game time clock 1216 output 1201 is input to the display logic 1218 that, as part of the ESE or GWE conditions this output for display to the player. The display logic can perform mathematical (for example integrate, subtract, add) and/or logical functions on the clock output and display the results of the function(s) and/or convey this information to the other subsystems within the GWE and/or ESE.

In a number of embodiments, a hockey themed entertainment game can include a shoot-out. A shoot out is a method of determining a winner by giving each team a number of opportunities (termed as rounds) to score on a goal defended only by an opponent's goalkeeper. In certain embodiments, each round of a shoot-out can be an AE whose consumption is a gambling event occurrence that triggers a wager in a gambling game. The wager payout can be used to determine an entertainment game modification that affects the number of rounds available to a player, the probability of scoring in a round or any other aspect of a hockey themed entertainment game.

In a number of embodiments, a hockey themed entertainment game can implement a tournament, such as but not limited to a tournament based off of the Stanley Cup (a championship series in professional ice hockey used to determine the winner of a championship trophy). In certain embodiments, a team in the tournament can win the tournament after winning 16 games and a team cannot lose more than four games in any round of the tournament. A hockey themed hybrid game can emulate a bracketed tournament where each team can have four losses (EE) that can be consumed during hockey themed entertainment game gameplay progression. Each loss or a win can be a gambling event occurrence that triggers a wager. A wager payout that is a positive result can cause generation of an entertainment game gameplay modification where additional losses can be consumed without losing the tournament. In certain embodiments, the structure of the tournament can involve a different number of teams and/or games to win the tournament including pool rounds and/or other structures designed to facilitate entertainment game gameplay. In particular embodiments, other entertainment game gameplay modifications can result from a wager payout, including but not limited to receiving a goal keeper that can perform with a higher save percentage than other goal keepers, or increased vitality, speed, or shot accuracy on the part of one or more of the characters on a team.

Although various constructions of hockey themed hybrid game implementations are discussed above, hockey themed hybrid games can be constructed to facilitate hockey themed hybrid game gameplay as appropriate to the specifications of a specific application in accordance with embodiments of the invention. Processing apparatuses that can be implemented in a hockey themed hybrid game are discussed below.

### Processing Apparatuses

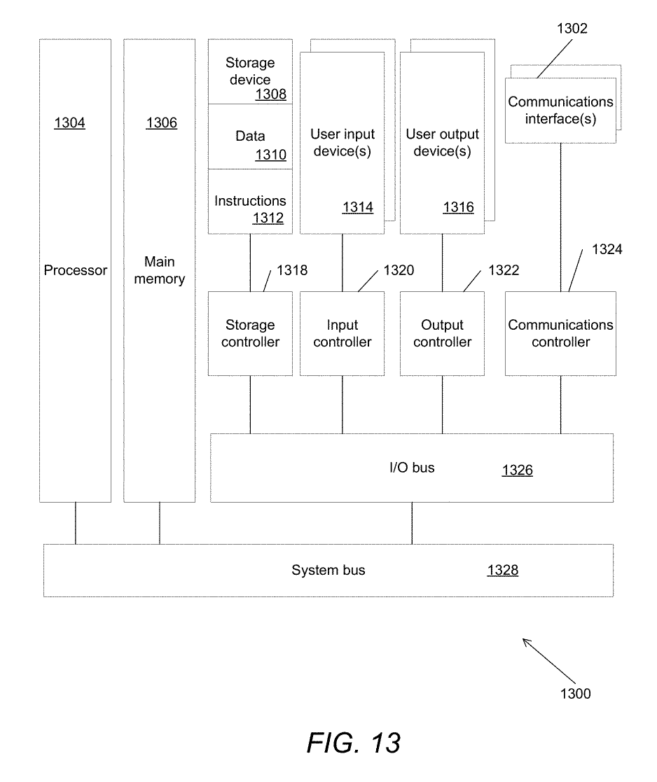

Any of a variety of processing apparatuses can host various components of a hockey themed hybrid game in accordance with embodiments of the invention. In several embodiments, these processing apparatuses can include, but are not limited to, a mobile device such as a tablet computer or a smartphone, a gaming machine, a general purpose computer, a computing device and/or a controller. A processing apparatus that is constructed to implement a hockey themed hybrid game in accordance with an embodiment of the invention is illustrated in FIG. 13. In the processing apparatus 1300, a processor 1304 is coupled to a memory 1306 by a bus 1328. The processor 1304 is also coupled to non-transitory processor-readable storage media, such as a storage device 1308 that stores processor-executable instructions 1312 and data 1310 through the system bus 1328 to an I/O bus 1326 through a storage controller 1318. The processor 1304 is also coupled to one or more interfaces that can be used to connect the processor to other processing apparatuses as well as networks as described herein. The processor 1304 is also coupled via the bus to user input devices 1314, such as tactile devices including but not limited to keyboards, keypads, foot pads, touch screens, and/or trackballs, as well as non-contact devices such as audio input devices, motion sensors and motion capture devices that the processing apparatus can use to receive inputs from a user when the user interacts with the processing apparatus. The processor 1304 is connected to these user input devices 1314 through the system bus 1328, to the I/O bus 1326 and through the input controller 1320. The processor 1304 is also coupled via the bus to user output devices 1316 such as (but not limited to) visual output devices, audio output devices, and/or tactile output devices that the processing apparatus uses to generate outputs perceivable by the user when the user interacts with the processing apparatus. In several embodiments, the processor is coupled to visual output devices such as (but not limited to) display screens, light panels, and/or lighted displays. In a number of embodiments, the processor is coupled to audio output devices such as (but not limited to) speakers, and/or sound amplifiers. In many embodiments, the processor is coupled to tactile output devices like vibrators, and/or manipulators. The processor is connected to output devices from the system bus 1328 to the I/O bus 1326 and through the output controller 1322. The processor 1304 can also be connected to a communications interface 1302 from the system bus 1328 to the I/O bus 1326 through a communications controller 1324.

In various embodiments, a processor can load instructions and data from the storage device into the memory. The processor can also execute instructions that operate on the data to implement various aspects and features of the components of a hockey themed hybrid game. The processor can utilize various input and output devices in accordance with the instructions and the data in order to create and operate user interfaces for players or operators of a hockey themed hybrid game (such as but not limited to a casino that hosts the hockey themed hybrid game).

Although the processing apparatus is described herein as being constructed from a processor and instructions stored and executed by hardware components, the processing apparatus can be composed of only hardware components in accordance with many embodiments. In addition, although the storage device is described as being coupled to the processor through a bus, those skilled in the art of processing apparatuses will understand that the storage device can include removable media such as but not limited to a USB memory device, an optical CD ROM, magnetic media such as tape and disks. Also, the storage device can be accessed through one of the interfaces or over a network. Furthermore, any of the user input devices or user output devices can be coupled to the processor via one of the interfaces or over a network. In addition, although a single processor is described, those skilled in the art will understand that the processor can be a controller or other computing device or a separate computer as well as be composed of multiple processors or computing devices.

In numerous embodiments, any of an RWE, GWE or ESE as described herein can be implemented on multiple processing apparatuses, whether dedicated, shared or distributed in any combination thereof, or can be implemented on a single processing apparatus. In addition, while certain aspects and features of element management processes described herein have been attributed to an RWE, GWE, or ESE, these aspects and features can be implemented in a distributed form where any of the features or aspects can be performed by any of a RWE, GWE, ESE within a hockey themed hybrid game without deviating from the spirit of the invention.

While the above description contains many specific embodiments of the invention, these should not be construed as limitations on the scope of the invention, but rather as an example of one embodiment thereof. It is therefore to be understood that the present invention can be practiced otherwise than specifically described, without departing from the scope and spirit of the present invention. Thus, embodiments of the present invention should be considered in all respects as illustrative and not restrictive.

What is claimed is:

1. A distributed gaming system, comprising:
an electromechanical gaming machine constructed to receive real credits from a player connected to a real world server by a communication link, wherein the real world server is constructed to:
receive from a game world server via the communication link, a trigger of a wager;
execute the wager to determine a randomly generated payout of real credits using a random number generator; and
distribute to the game world server via the communication link, the payout of real credits;
an entertainment software server connected to the game world server by a network, wherein the entertainment software server is constructed to:
execute a hockey-themed entertainment game having a game world clock in a game world environment and an entertainment game element that is controlled by an action of a player in the game world environment;
distribute to the game world server via the network, an output of the game world clock and the player action;
receive from the game world server via the network, control information including an period of time in the game world environment;
make available to the player the period of time in the game world environment during the player's play of the hockey-themed entertainment game; and
provide outcomes based upon the player's skillful play of the hockey-themed entertainment game and use of the period of time in the game world environment; and
generate a perceivable output of the action taken by the player in the game world environment on a user interface device;
the user interface device connected to the hockey-themed entertainment software server, wherein the user interface device is configured to:
depict a representation of the themed hockey-themed entertainment game; and
receive instructions for actions taken by the player; and
the game world server connected by the communication link to the real world server and connected to entertainment software server by the network, wherein the game world server is constructed to:
interface the entertainment software server to the real world server over the network by:
receiving from the entertainment software server via the network, the output of the game world clock and the player action in the game world environment;
monitoring the output of the game world clock during the player's play of the hockey-themed entertainment game;
detecting passage of a unit of game world time in the game world environment based on the monitored output of the game world clock;
distributing to the real world server via the communication link, the trigger of the wager based on both the detection of the passage of the unit of game world time in the game world environment and on the action of the player in the game world environment;
receiving from the real world server via the communication link, the randomly generated payout; and
controlling the entertainment software server by:
determining, based on the randomly generated payout, the control information including the period of time in the game world environment available to the player while playing the hockey-themed entertainment game;
distributing to the entertainment software server via the network, the control information; and
accreting, based on the randomly generated payout, an amount of game world time in the game world environment for use by the player while playing the hockey-themed entertainment game.

2. The distributed gaming system of claim 1, wherein the game world server distribution of the trigger of the wager further includes the amount of real credit committed to the wager.

3. The distributed gaming system of claim 2, wherein the amount of real credit committed to the wager is determined on the basis of the unit of game world time.

4. The distributed gaming system of claim 1, wherein the game world server and the real world server are implemented on a same processing apparatus.

5. The distributed gaming system of claim 1, wherein the communication link connecting the game world server and the real world server utilizes the network.

6. The distributed gaming system of claim 1, wherein the action of the player in the game world environment to trigger the wager includes the player directing a virtual object into an opponent's goal during a gameplay session of the hockey-themed entertainment game.

7. The distributed gaming system of claim 1, wherein the user interface device is further configured to display a player profile for the player of the hockey-themed entertainment game.

8. The distributed gaming system of claim 1, wherein the action of the player in the game world environment to trigger the wager includes a distance traveled by a virtual character in the hockey-themed entertainment game.

9. A distributed gaming system, comprising:
an electromechanical gaming machine constructed to receive real credits from a player and connected to a real world server by a communication link, wherein the real world server is constructed to execute a wager;
a game world server connected by the communication link to the real world server and connected to an entertainment software server by the network, wherein the game world server is constructed to:
interface the entertainment software server to the real world server over the network by:
receiving from the entertainment software server via the network, an output of a game world clock and a player action in a game world environment;
monitoring the output of the game world clock during the player's play of a hockey-themed entertainment game;
detecting passage of a unit of game world time in the game world environment based on the monitored output of the game world clock;
distributing to the real world server via the communication link, a trigger of the wager based on both the detection of the passage of the unit of game world time in the game world environment and on the action of the player in the game world environment;
receiving from the real world server via the communication link, a randomly generated payout; and
controlling the entertainment software server by:
determining, based on the randomly generated payout, control information including a period of time in the game world environment available to the player while playing the hockey-themed entertainment game;
distributing to the entertainment software server via the network, the control information; and
accreting, based on the randomly generated payout, an amount of game world time in the game world environment for use by the player while playing the hockey-themed entertainment game.

10. The distributed gaming system of claim 9, wherein the game world server distribution of the trigger of the wager further includes the amount of real credit committed to the wager.

11. The distributed gaming system of claim 10, wherein the amount of real credit committed to the wager is determined on the basis of the unit of game world time.

12. The distributed gaming system of claim 9, wherein the game world server and the real world server are implemented on a same processing apparatus.

13. The distributed gaming system of claim 9, wherein the communication link connecting the game world server and the real world server utilizes the network.

14. The distributed gaming system of claim 9, wherein the action of the player in the game world environment to trigger the wager includes the player directing a virtual object into an opponent's goal during an entertainment game gameplay session.

15. The distributed gaming system of claim 9, wherein the user interface device is further configured to display a player profile for the player of the entertainment game.

16. The distributed gaming system of claim 1, wherein the action of the player in the game world environment to trigger the wager includes a distance traveled by a virtual character in the hockey-themed entertainment game.
